(19) United States
(12) Patent Application Publication
(10) Pub. No.: US 2002/0075688 A1
(43) Pub. Date: Jun. 20, 2002

(54) Support means for light fitting

(76) Inventor: Anu Moser, Stillingson (SE)

Correspondence Address: Samuels, Gauthier & Stevens LLP, Suite 3300, 225 Franklin Street, Boston, MA, 02110, US

(21) Appl. No.: 09/871,109

(22) Filed: May 31, 2001

Related U.S. Application Data
(63) Continuation of application No. PCT/SE99/02246, filed on Dec. 1, 1999.

(30) Foreign Application Priority Data
Dec. 2, 1998 (SE) 9804163-5

(51) Int. Cl. F21V 21/00

(52) U.S. Cl. 362/396; 362/403; 362/455

(57) ABSTRACT

Support means for light fittings incorporating a lamp globe (1) provided with an opening (2) through which is insertable a lamp cap (4), and incorporating a distribution element (6) provided substantially just in front of the opening in the lamp globe and equipped with a number of retaining members (8) distributed around the opening in the lamp globe and retaining the lamp globe with a tension force, whereby the retaining members are constituted by elongated, wire-like attachment members (8) projecting from the distribution element (6), and the ends (9) of which, facing the lamp globe, are attachable for hooking to corresponding receiving members (10) of the lamp globe.

The present invention refers to light fittings and more particularly to support means for light fittings of the type defined in the preamble of claim 1.

Means of suspending or support of light fittings are known in a plurality of different designs and shapes. A common design of such suspension means or support devices is that a flange or the like of the lamp globe is fitted by being screwed in between parts of the bulb retaining cap, that can be screwed against each other. This requires however that there is unlimited accessibility to both sides of the lamp globe.

From aesthetic reasons it however often can be desirable to use lamp globes, which form substantially completely closed hollow bodies, apart from an opening necessary for insertion of the lamp cap and the bulb and for lead-through of an electric cord connected to the lamp cap.

This presents a problem as it is not possible in a simple manner to design, e.g. blown glass globes with built-in means for attachment and it is neither possible to get access to the interior of the opening.

From U.S. Pat. No. 940,530 and U.S. Pat. No. 1,267,865 it has earlier been suggested for a moulded glass globe, which forms a closed hollow body with only one opening for the lamp cap, etcetera, to mould the glass around the opening with a V-shaped groove and this lamp globe is attached to a tubular sheet metal socket by means of screws being screwed through threaded through-holes in the sheet metal socket and which with their screw tips project into the V-shaped groove and thereby will retain the lamp globe.

For lamp globes in the form of artistic glass it is however more difficult to design the openings of the globes in such a manner, that this type of attachment means are useful, and the screw joint and the sheet metal socket used as fitting give furthermore a design of less appealing appearance, which at the same time requires a rather heavy and troublesome work, at least when it concerns more heavy lamp globes.

The purpose of the present invention is to provide a support means for light fittings incorporating a lamp globe equipped with an opening through which a lamp socket is insertable, and which incorporates a distribution element provided mainly just in front of the opening in the lamp globe and which is equipped with a number of retaining means distributed around the opening in the lamp globe, and retaining the lamp globe with a tension force, whereby also blown artistic glass without especial flanges or grooves being formed in the glass, can be attached in a simple and reliable manner, without the attachment thereby meaning any difficult work, and this is achieved by a means according to the characterizing part of claim 1.

Hereinafter the invention will be further described with reference to embodiments schematically illustrated in the accompanying drawings.

FIG. 1 shows, partly in cross section, a first embodiment of a support means for a light fitting in mounted position.

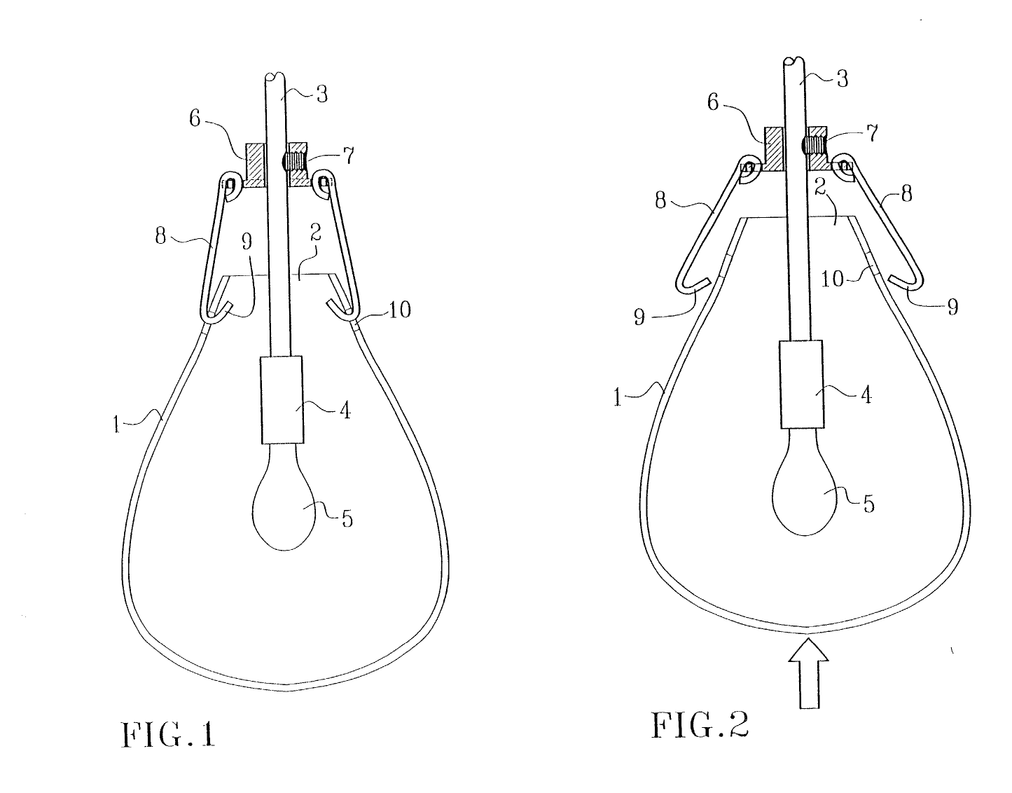

FIG. 2 is a corresponding view, which illustrates the lamp suspension according to FIG. 1 during dismounting.

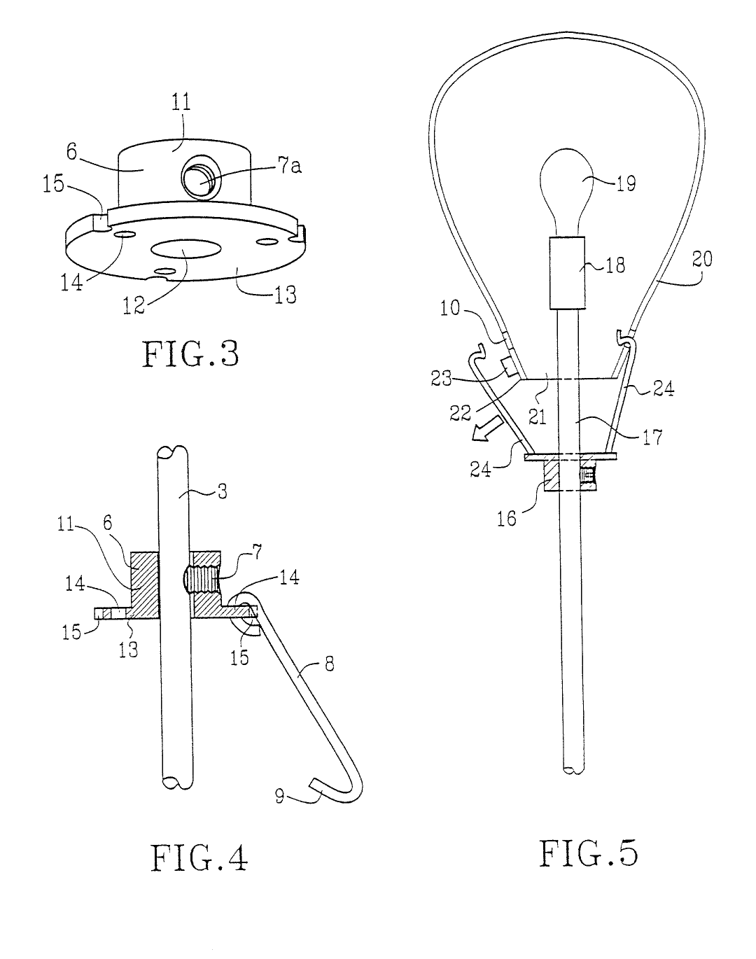

FIG. 3 shows in perspective an embodiment of a distribution element forming part of the support means.

FIG. 4 shows in side view a distribution element with an attachment means and applied to a support means, and

FIG. 5 illustrates a schematically shown alternative embodiment of a support means according to the invention partly in cross section.

In FIG. 1 is illustrated in cross-section a glass globe 1, e.g. of drip or pear shape, and which constitutes a substantially closed hollow body, except from a through-opening 2 provided at its narrower part, and through which passes an electric cord 3 for current supply to a light bulb 5 screwed into a lamp socket 4. The size of the opening 2 is such that the lamp socket 4 as well as the light bulb 5 can pass there trough without problems.

By the design of the lamp globe 1 as a substantially closed hollow body it is not possible to use the conventional type of suspension arrangement, as this requires accessibility from the side where the light bulb is situated.

The suspension according to the invention is instead constituted of a distribution element 6, in the embodiment shown in the form of a tubular flanged sleeve, a preferred form of which will be further illustrated and described in connection to FIG. 3. This distribution element 6 is affixed to a support means, which in the embodiment shown is the electric supply cord 3 for the light fitting, which in this case is suspended from above, but which alternatively may be constituted by one or more suspension elements, which not have any other function at the same time.

The distribution element 6 is secured to the support means the electric cord 3—by means of a clamping device 7, which is preferably constituted by a locking screw, and along the periphery of its flange circumference the distribution element supports a number of equidistantly spaced apart retaining members 8, in form of elongated, wire-shaped attachment members, which in the embodiment shown are constituted by wires which are rigid against flexing, and which are pivotally suspended in the distribution element, and which at their ends turned away from the distribution element are designed with hook-formed ends 9. In the embodiment shown, these ends 9 are insertable in corresponding smaller through-holes 10 provided in the glass of the lamp globe at a distance from and distributed around the opening 2 in the lamp globe, and when these hook-formed ends 9 have been inserted in the holes 10 in the lamp globe and this hangs therein the weight of the lamp causes a force component of the gravity of the globe to provide a tensile force, which in a safe manner retains the hooks in the holes 10.

In FIG. 2 is illustrated how the lamp globe 1 in a simple manner can be dismounted from the suspension device by being lifted upwards with a force, which is represented by the arrow A in the figure, and which force is bigger than the force of gravity of the globe. At this lift of the globe 1, the flexurally stiff attachment members 8 will be moved out of engagement with the holes 10 and the lamp globe can be removed.

When mounting the lamp globe 1 the procedure is the corresponding, i.e. the opening 2 of the lamp globe is positioned thus that it is situated just below the hanging light bulb 5. The lamp globe 1 is aligned thus that the holes 10 therein are situated just in front of the down hanging attachment members, and the globe is then lifted upwards. Hereby the attachment members 8, while pivoting about their different pivot points in the distribution element 6 will follow the curvature of the lamp globe and be moved outwards with their hook ends 9, until the hooks will fall into the holes 10. When the lifting of the globe is terminated the hook ends 9 will hitch into the holes 10 and again be clamped thereto by the gravity of the lamp globe.

In FIG. 3 is shown in perspective an embodiment of a distribution element 6 forming part of the supporting member for the light fitting according to the invention, which in the embodiment shown is made as a flanged sleeve with a cylindric sleeve 11 having an axial through-hole 12 and a radial flange 13 provided at one end of the sleeve. In this radial flange 13 is provided axial holes 14 distributed around the circumference of the flange, and each of which are intended to receive the upper portion of one of the attachment means 8. In the flange edge outside the different holes 14 there is preferably provided an axial groove 15, for centering and guiding the attachment member. In the cylindric sleeve 11 is arranged a radial threaded through-bore 7a.

In FIG. 4 is shown in side elevation the distribution element 6 in accordance with FIG. 3, with the element attached to the support means in the form of the current supply or electrical cord 3, by means of a stop screw 7 screwed in through the bore 7a illustrated in FIG. 3, thus that the screw tip presses against the cord or against a (not shown) clamping pawl provided between the screw tip and the cord 3. In this figure it is also shown how an attachment member in form of the flexurally stiff, wire-formed element 8 is pivotally suspended in the hole 14 in the flange 13.

In FIG. 5 is shown in cross-section another embodiment of a support means for a light fitting in accordance with the present invention.

In this case the invention is encompassed by a distribution element 16 designed as a lamp foot, which supports an upright 17 for a lamp cap 18 with a light bulb 19. In this case the lamp globe 20 is provided with an outwardly directed flange 22 around its opening 21, which flange acts as attachment for a collar 23 fitted around the circumference of the flange, and which can be equipped with not further shown gripping spaces (e.g. holes). The distribution element 16 supports a number of attachment members 24 distributed along its circumference, and being in the form of elongated, wire-like members, which in this case are rigidly affixed in the distribution element, but which are made of a resilient material, which in affixed position provides a retaining spring force against the lamp globe. Due to the fact that the attachment members 24 thus, such as illustrated with the arrow B, can be moved out of engagement with the gripping spaces in the collar 23, or alternatively out of holes 10 in the lamp globe, corresponding to the holes at the embodiment according to FIGS. 1 and 2, the lamp globe 20 in this case can be affixed to or released from the support means as easily as at the earlier shown embodiment with a suspended light fitting.

The invention is not limited to the two embodiments illustrated in the accompanying drawings and described in connection thereto, but modifications and variants are possible within the scope of the accompanying claims.

1. Support means for light fitting incorporating a lamp globe (1,20) provided with an opening (2,21) through which is insertable a lamp cap (4,18), and incorporating a distribution element (6,16) provided substantially just in front of the opening in the lamp globe and equipped with a number of retaining members (8, 24) distributed around the opening in the lamp globe and retaining the lamp globe with a tension force,
characterized therein,
that the retaining members are constituted by elongated, wire-like attachment members (8, 24) projecting from the distribution element (6,16), and the ends (9) of which facing the lamp globe are attachable for hooking to corresponding receiving members (10, 23) of the lamp globe.

2. Support means according to claim 1,
characterized therein,
that the ends (9) of the attachment members (8, 24) facing away from the distribution element (6,16) are hook-formed and adapted to be hooked to corresponding receiving members (10) in the form of openings (10) distributed about the opening (2) of the lamp globe.

3. Support means according to claim 1 or 2,
characterized therein,
that the receiving members associated with the lamp globe (1, 20) are constituted by holes (10) provided direct in the glass of the lamp globe, or in a retaining collar (23) affixed externally around the opening of the lamp globe.

4. Support means according to claims 1-3, for light fittings of the type incorporating at least one hanging suspension member (3)
characterized therein,
that the suspension member (3) supports the distribution element (6), which is attached thereto, and that the elongated, wire-formed attachment members (8) are flexurally stiff and pivotally suspended in the distribution element, whereby the tensioning force required for the retainment is constituted by a component of the gravity from the lamp globe (1) hanging from the attachment members (8).

5. Support means according to claim 4,
characterized therein,
that the suspension member is constituted by a current supply cord (3) connected to the lamp cap (4).

6. Support means according to anyone of the preceeding claims,
characterized therein,
that the distribution element (6) is constituted by a flanged sleeve having an axial through-hole (12) adapted to be fitted about the suspension member (3) and to be affixed to this.

7. Support means according to claim 1-3,
characterized therein,
that the distribution element (16) is supported by a lamp foot, whereby the elongated, wire-formed attachment members (24) supported by the distribution element and distributed around the opening (21) in the light fitting (20) are non-pivotally connected to the distribution element and made of a resilient material, whereby the tension force required for the retainment is provided by the resilient properties of the attachment members.

8. Support means according to anyone of the preceeding claims,
characterized therein,
that the lamp globe (1, 20) forms a completely closed hollow body except for its opening (2, 21) for the lamp cap (4,18).
